(19) United States
(12) Patent Application Publication
(10) Pub. No.: US 2011/0179868 A1
(43) Pub. Date: Jul. 28, 2011

(54) PHYSICAL QUANTITY SENSOR SYSTEM AND PHYSICAL QUANTITY SENSOR DEVICE

(75) Inventors: Yoichi KAINO, Osaka (JP); Motonori Taniguchi, Kyoto (JP); Fumihito Inukai, Kyoto (JP)

(73) Assignee: Panasonic Corporation, Osaka (JP)

(21) Appl. No.: 13/085,823

(22) Filed: Apr. 13, 2011

Related U.S. Application Data
(63) Continuation of application No. PCT/JP2009/002527, filed on Jun. 4, 2009.

(30) Foreign Application Priority Data
Feb. 10, 2009 (JP) 2009-028805

(51) Int. Cl. G01P 15/097

(52) U.S. Cl. 73/504.12

(57) ABSTRACT

A physical quantity sensor system drives a physical quantity sensor and detects a physical quantity signal from a sensor signal. An analog-to-digital conversion circuit respectively converts a monitor signal and the sensor signal to a digital monitor signal and a digital sensor signal. A drive control circuit controls a drive signal according to the digital monitor signal. A phase adjustment circuit adjusts the phase difference between the digital monitor signal and the digital sensor signal. A detection circuit detects the physical quantity signal by multiplying the digital monitor signal by the digital sensor signal after the phase difference adjustment by the phase adjustment circuit.

### CROSS-REFERENCE TO RELATED APPLICATION

This is a continuation of PCT International Application PCT/JP2009/002527 filed on Jun. 4, 2009, which claims priority to Japanese Patent Application No. 2009-028805 filed on Feb. 10, 2009. The disclosures of these applications including the specifications, the drawings, and the claims are hereby incorporated by reference in their entirety.

### BACKGROUND

The present disclosure relates to a physical quantity sensor system and a physical quantity sensor device including the same.

Conventionally, physical quantity sensors capable of detecting a physical quantity (e.g., an angular velocity, an acceleration, etc.) are used in a variety of technical fields such as detection of shake of a digital camera, attitude control of a mobile unit (e.g., an aircraft, an automobile, a vessel, a robot, etc.), and guidance of a missile and a spacecraft. In recent years, with the progress of the circuit nanotechnology, digitization of physical quantity sensor systems is on its way to further advance. Japanese Patent Publication No. H03-54476 (Patent Document 1) discloses a signal processing circuit for a biaxial angular velocity/acceleration sensor, which is constituted by digital circuits. In this signal processing circuit, an analog-to-digital converter converts a signal output from the sensor to a digital signal, a sine wave signal generation means generates a digital sine wave signal, and a multiplier means multiplies the digital signal from the analog-to-digital converter by the digital sine wave signal. The sine wave signal generation circuit has a memory that stores a plurality of digital values (sine values) for reproduction of the digital sine wave signal, and reads such digital values from the memory sequentially at predetermined timing, thereby to generate the digital sine wave signal.

### SUMMARY

The signal processing circuit of Patent Document 1 has the following problem. When it is intended to express each sine value by a digital value correctly for improvement of detection precision, the bit length of the digital value will be large. Also, when it is intended to express a sine waveform by a plurality of digital values correctly for improvement of detection precision, the number of digital values will increase. Increases in the bit length of each digital value and the number of digital values will increase the information amount stored in the memory, resulting in increase in memory region. For this reason, in the signal processing circuit of Patent Document 1, in which a plurality of digital values for reproduction of the digital sine wave signal must be stored in the memory, it is difficult to reduce the circuit area.

It is an objective of the present disclosure to provide a physical quantity sensor system that can eliminate the necessity of storing a plurality of digital values for reproduction of a digital sine wave signal.

According to one aspect of the present invention, the physical quantity sensor system is a system configured to drive a physical quantity sensor that vibrates from self-excitation by application of a drive signal to output a monitor signal responsive to the self-excited vibration and also output a sensor signal according to a physical quantity given externally, and detect a physical quantity signal corresponding to the physical quantity from the sensor signal, the system including: an analog-to-digital conversion circuit configured to convert the monitor signal and the sensor signal to a digital monitor signal and a digital sensor signal, respectively: a drive control circuit configured to control the drive signal according to the digital monitor signal; a phase adjustment circuit configured to adjust the phase difference between the digital monitor signal and the digital sensor signal so that the phases of the digital monitor signal and the digital sensor signal match with each other; and a detection circuit configured to detect the physical quantity signal by multiplying the digital monitor signal by the digital sensor signal after the phase difference adjustment by the phase adjustment circuit. In this physical quantity sensor system, a digital signal for detection of the physical quantity signal from the digital sensor signal is generated by digitizing the monitor signal. This can eliminate the necessity of storing a plurality of digital values for reproduction of a digital sine wave signal, and thus can reduce the circuit scale of the physical quantity sensor system. Also, the detection precision can be improved without increasing the circuit scale.

The analog-to-digital conversion circuit may operate in synchronization with a sampling clock generated using the monitor signal as frequency reference. With this configuration, since the monitor signal can be digitized correctly, the detection precision can be further improved.

The analog-to-digital conversion circuit may selectively perform first analog-to-digital conversion processing of converting the monitor signal to the digital monitor signal and second analog-to-digital conversion processing of converting the sensor signal to the digital sensor signal. By digitizing both the monitor signal and the sensor signal with the common analog-to-digital converter, the differences in amplitude and phase between the digital monitor signal and the digital sensor signal can be reduced. This can further improve the detection precision.

Preferably, the drive control circuit includes an amplitude detection circuit configured to detect an amplitude value of the digital monitor signal, a gain adjustment circuit configured to amplify or attenuate the digital monitor signal according to the amplitude value detected by the amplitude detection circuit, and a digital-to-analog conversion circuit configured to convert the digital monitor signal amplified or attenuated by the gain adjustment circuit to the drive signal. By digitizing the drive control circuit in this way, variations in the amplitude of the drive signal due to fluctuations in power supply voltage and changes in temperature can be suppressed or reduced, and thus the vibration velocity of the physical quantity sensor can be stabilized.

The phase adjustment circuit may include a shift register configured to delay the digital monitor signal. With this configuration, the phase of the digital monitor signal can be adjusted, and thus the phase difference between the digital monitor signal and the digital sensor signal can be adjusted.

The shift register may shift the digital monitor signal sequentially to generate a plurality of delayed digital monitor signals different in phase from each other, and the phase adjustment circuit may include a selector configured to select one of the plurality of delayed digital monitor signals and supply the selected one to the detection circuit. With this configuration, the phase shift amount of the digital monitor signal can be changed.

Alternatively, the phase adjustment circuit may include a Hilbert transformer configured to perform Hilbert-transformation on the digital monitor signal to generate a first digital signal that lags behind the digital monitor signal in phase and a second digital signal that leads the digital monitor signal in phase, the drive control circuit may control the drive signal according to the first digital signal, and the detection circuit may multiply the digital sensor signal by the second digital signal. With this configuration, the phase difference between the digital monitor signal and the digital sensor signal can be reduced, and also the phase of the drive signal can be adjusted.

The Hilbert transformer may include a plurality of delay circuits configured to shift the digital monitor signal sequentially to generate a plurality of delayed digital monitor signals different in phase from each other, a plurality of multipliers configured to multiply the plurality of delayed digital monitor signals by a constant, and an addition circuit configured to output the total of outputs of the plurality multipliers as the second digital signal, and the phase adjustment circuit may include a selector configured to select one of the plurality of delayed digital monitor signals and output the selected one as the first digital signal. With this configuration, the phase shift amount of the first digital signal can be changed.

Preferably, the physical quantity sensor system further includes a sampling phase adjustment circuit configured to adjust the phase of a sampling clock, wherein the analog-to-digital conversion circuit operates in synchronization with the sampling clock phase-adjusted by the sampling phase adjustment circuit. With this configuration, since the monitor signal and the sensor signal can be digitized correctly, the detection precision can be improved. Also, since the phase difference between the digital monitor signal and the digital sensor signal can be adjusted, the detection precision can be further improved.

Preferably, the physical quantity sensor system further includes a startup control circuit configured to start up the drive control circuit and also start up the detection circuit when the self-excited vibration of the physical quantity sensor becomes stable. With this configuration, false detection of the physical quantity signal by the detection circuit can be prevented.

The physical quantity sensor system may further include: an amplifier configured to amplify the monitor signal; a feedback switch configured to be switchable between a feedback state of allowing feedback of an output of the amplifier as the drive signal and a shutoff state of prohibiting feedback of the output of the amplifier as the drive signal; and a clock generation circuit configured to generate a sampling clock based on the output of the amplifier, wherein the analog-to-digital conversion circuit may operate in synchronization with the sampling clock, and the startup control circuit may start up the clock generation circuit and also set the feedback switch to the feedback state, and, when the sampling clock becomes stable, start up the drive control circuit and also set the feedback switch to the shutoff state. With this configuration, the drive control circuit can control the drive signal normally based on the normal digital monitor signal.

The clock generation circuit may include a phase locked loop (PLL) configured to be switchable between a closed loop state and an open loop state, and the startup control circuit may start up the PLL in the open loop state, and set the PLL to the closed loop state when the startup of the PLL is completed. With this configuration, the frequency of the sampling clock can be stabilized.

### BRIEF DESCRIPTION OF THE DRAWINGS

FIG. 1 is a view showing an example configuration of a physical quantity sensor device of the first embodiment.

FIG. 2 is a view showing an example configuration of a physical quantity sensor shown in FIG. 1.

FIG. 3 is a view showing an example configuration of a clock generation circuit shown in FIG. 1.

FIG. 4 is a view illustrating the operation of a physical quantity sensor system shown in FIG. 1.

FIG. 5 is a view showing an example configuration of a drive control circuit shown in FIG. 1.

FIG. 6 is a view showing an example configuration of a phase adjustment circuit shown in FIG. 1.

FIG. 7 is a view showing an example configuration of a physical quantity sensor system of the second embodiment.

FIG. 8 is a view showing an example configuration of a physical quantity sensor system of the third embodiment.

FIG. 9 is a view illustrating startup control by a startup control circuit shown in FIG. 8.

FIG. 10 is a view illustrating a variation of the clock generation circuit.

FIG. 11 is a view illustrating startup control for the clock generation circuit of FIG. 10.

FIG. 12 is a view illustrating a variation of the startup control circuit shown in FIG. 8.

FIG. 13 is a view illustrating the first variation of the drive control circuit.

FIG. 14 is a view illustrating the second variation of the drive control circuit.

FIG. 15 is a view illustrating the third variation of the drive control circuit.

FIG. 16 is a view showing an example configuration of a ΔΣ modulation circuit shown in FIG. 15.

FIG. 17 is a view illustrating the first variation of the phase adjustment circuit.

FIG. 18 is a view showing an example configuration of the phase adjustment circuit shown in FIG. 17.

FIG. 19 is a view illustrating the second variation of the phase adjustment circuit.

FIG. 20 is a view illustrating the third variation of the phase adjustment circuit.

FIG. 21 is a view illustrating the first variation of the clock generation circuit.

FIG. 22 is a view illustrating the second variation of the clock generation circuit.

FIG. 23 is a view illustrating the third variation of the clock generation circuit.

FIG. 24 is a view illustrating the fourth variation of the clock generation circuit.

### DETAILED DESCRIPTION

Preferred embodiments will be described in detail with reference to the drawings. It should be noted that same or similar components are denoted by the same reference characters throughout the drawings, and description thereof will not be repeated.

### First Embodiment

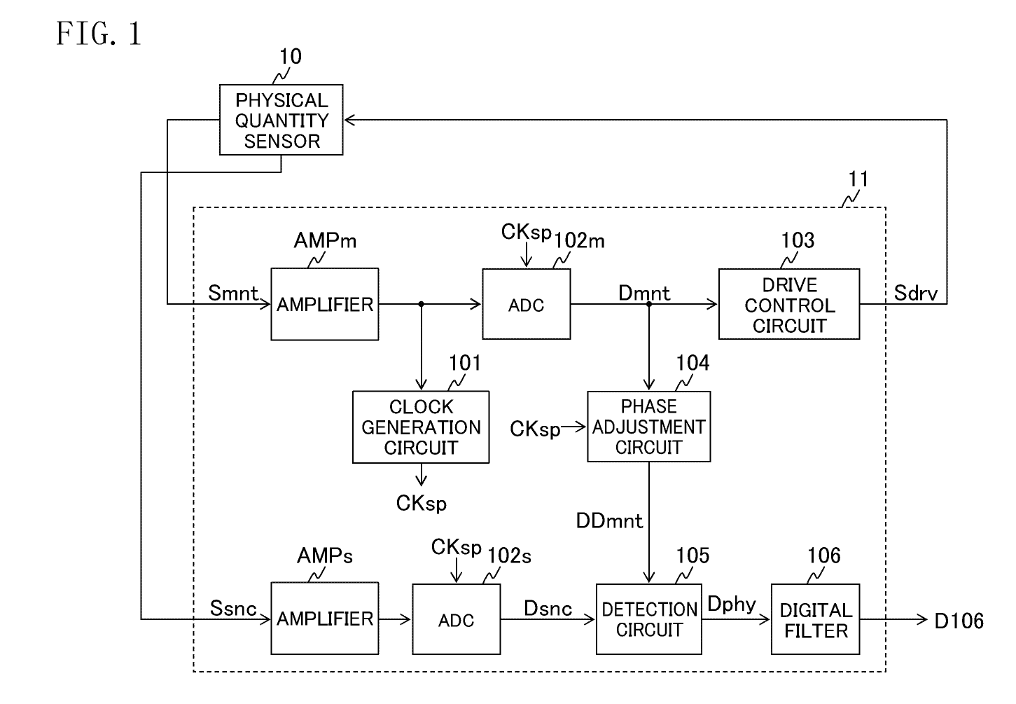

FIG. 1 shows an example configuration of a physical quantity sensor device of the first embodiment. This physical quantity sensor device includes a physical quantity sensor 10 and a physical quantity sensor system 11.

[Physical Quantity Sensor]

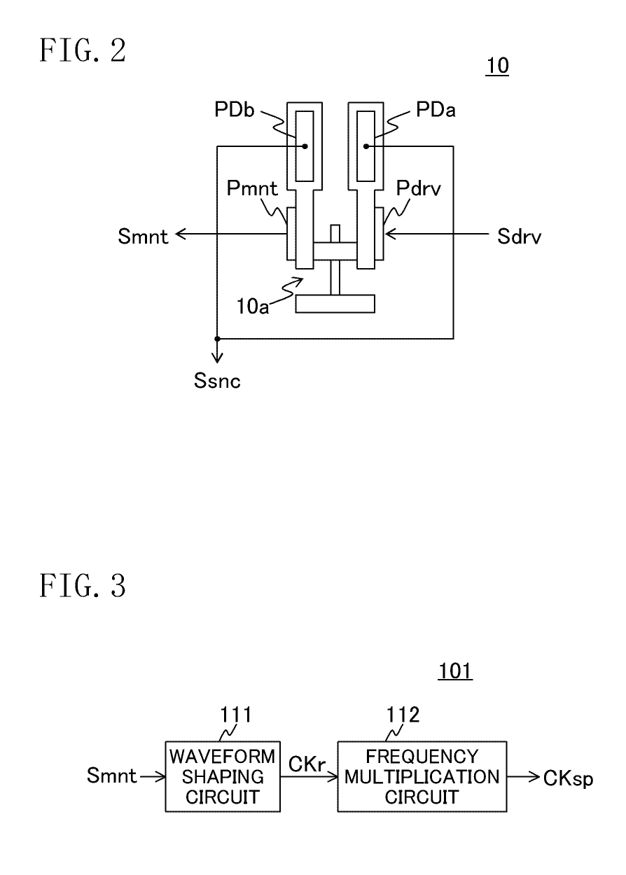

The physical quantity sensor 10 vibrates from self-excitation by application of a drive signal Sdrv and outputs a monitor signal Smnt responsive to the self-excited vibration. Also, the physical quantity sensor 10 outputs a sensor signal Ssnc according to a physical quantity (e.g., an angular velocity, an acceleration, etc.) given externally. In this embodiment, the physical quantity sensor 10 is described as a tuning fork type angular velocity sensor. As shown in FIG. 2, for example, the physical quantity sensor 10 includes a tuning fork body 10a, a drive piezoelectric element Pdrv, a monitor piezoelectric element Pmnt, and sensor piezoelectric elements PDa and PDb. The tuning fork body 10a has two prongs each twisted by the right angle in the center, a connection for connecting the two prongs at their ends on one side, and a support pin provided at the connection to serve as a rotation axis. The drive piezoelectric element Pdrv vibrates one prong according to the drive signal Sdrv, and this causes resonance of the two prongs. With this vibration of the tuning fork, charge is generated in the monitor piezoelectric element Pmnt (i.e., the monitor signal Smnt is generated). Also, when a rotational angular velocity (Coriolis force) is generated, an amount of charge corresponding to the rotational angular velocity is generated in the sensor piezoelectric elements PDa and PDb (i.e., the sensor signal Ssnc is generated). The sensor signal Ssnc includes a superimposed physical quantity signal corresponding to the physical quantity given to the physical quantity sensor 10. In other words, the sensor signal Ssnc (e.g., several tens of kHz) has been amplitude-modulated with the physical quantity signal (e.g., several Hz).

[Physical Quantity Sensor System]

Returning back to FIG. 1, the physical quantity sensor system 11 includes amplifiers AMPm and AMPs, a clock generation circuit 101, analog-to-digital converters (ADCs) 102m and 102s, a drive control circuit 103, a phase adjustment circuit 104, a detection circuit 105, and a digital filter 106.

The amplifier AMPm amplifies the monitor signal Smnt from the physical quantity sensor 10, and the amplifier AMPs amplifies the sensor signal Ssnc from the physical quantity sensor 10. The clock generation circuit 101 generates a sampling clock CKsp based on the monitor signal Smnt supplied via the amplifier AMPm. As shown in FIG. 3, the clock generation circuit 101 includes, for example: a waveform shaping circuit 111 that converts the monitor signal Smnt from the amplifier AMPm to a square wave and outputs the result as a reference clock CKr; and a frequency multiplication circuit 112 that multiplies the frequency of the reference clock CKr and outputs the result as the sampling clock CKsp. The wave shaping circuit 111 is constituted by a comparator, for example, and the frequency multiplication circuit 112 is constituted by a phase locked loop (PLL), for example.

The ADC 102m converts the monitor signal Smnt supplied via the amplifier AMPm to a digital monitor signal Dmnt in synchronization with the sampling clock CKsp. The ADC 102s converts the sensor signal Ssnc supplied via the amplifier AMPs to a digital sensor signal Dsnc in synchronization with the sampling clock CKsp. The drive control circuit 103 controls the drive signal Sdrv according to the digital monitor signal Dmnt from the ADC 102m so that the amplitude of the monitor signal Smnt is kept constant. The phase adjustment circuit 104 adjusts the phase difference between the digital sensor signal Dsnc and the digital monitor signal Dmnt so that the phases of these signals match with each other. In this embodiment, the phase adjustment circuit 104 delays the digital monitor signal Dmnt in synchronization with the sampling clock CKsp and outputs the result as a delayed digital monitor signal DDmnt. The detection circuit 105 multiplies the delayed digital monitor signal DDmnt by the digital sensor signal Dsnc, thereby to detect a physical quantity signal Dphy corresponding to the physical quantity given to the physical quantity sensor 10. The detection circuit 105 is constituted by a multiplier, for example. The digital filter 106 removes a noise component included in the physical quantity signal Dphy and outputs the result as a physical quantity signal D106. The digital filter 106 is constituted by a low-pass filter, for example.

[Operation]

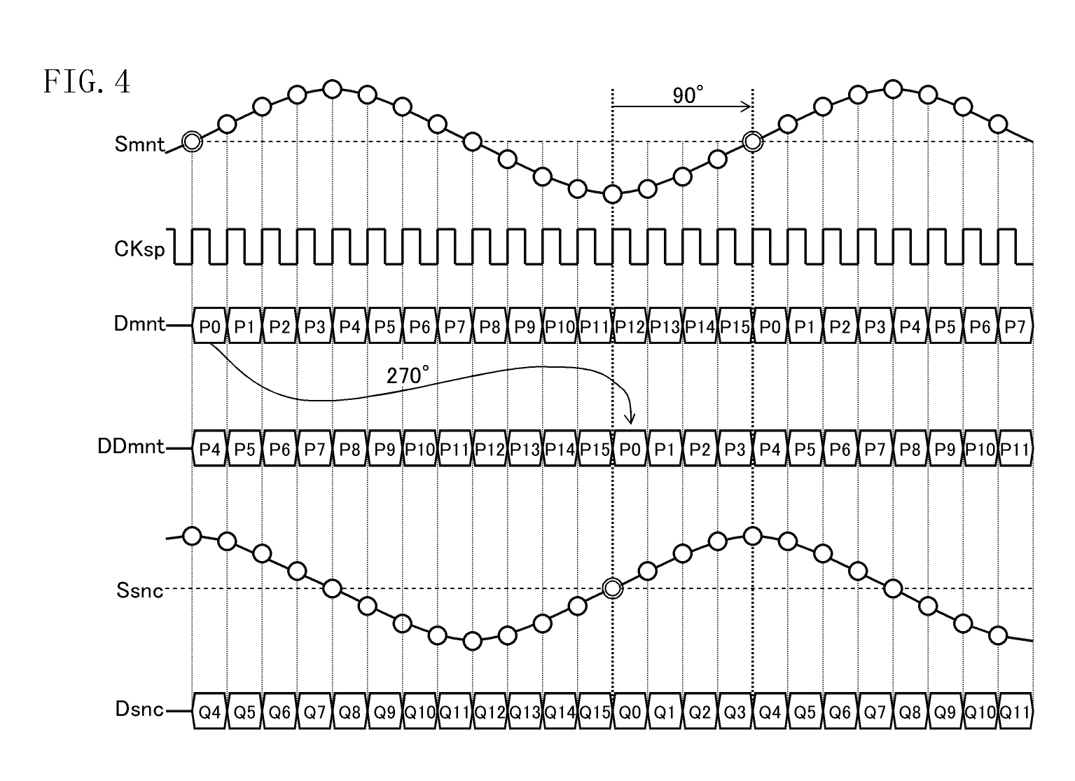

The operation of the physical quantity sensor system shown in FIG. 1 will be described with reference to FIG. 4. The phase of the monitor signal Smnt lags 90° behind the phase of the sensor signal Ssnc due to the principle of generation of Coriolis force. First, the monitor signal Smnt and the sensor signal Ssnc are respectively converted to the digital monitor signal Dmnt constituted by digital values P0, P1, . . . and the digital sensor signal Dsnc constituted by digital values Q0, Q1, . . . . Thereafter, the phase of the digital monitor signal Dmnt is delayed by 270° (i.e., advanced by 90°. The phase of the resultant delayed digital monitor signal DDmnt matches with the phase of the digital sensor signal Dsnc. The detection circuit 105 then multiplies the digital values P0, P1, . . . by the digital values Q0, Q1, . . . respectively, whereby the physical quantity signal Dphy is detected.

As described above, by digitizing the monitor signal Smnt, the digital signal for detection of the physical quantity signal Dphy from the digital sensor signal Dsnc is obtained. This can eliminate the necessity of storing a plurality of digital values for reproduction of the digital sine wave signal, permitting reduction in the circuit scale of the physical quantity sensor system.

Also, the higher the sampling frequency (the frequency of the sampling clock CKsp), the more the quantization noise can be reduced, and thus the more the detection precision can be improved. In particular, the quantization noise reduction effect will be significant for a ΔΣ analog-to-digital circuit, compared with for the other types of analog-to-digital converters. Conventionally, the higher the sampling frequency, the larger the number of digital values for reproduction of the digital sine wave signal becomes. In this embodiment, however, since it is unnecessary to store such digital values, the detection precision can be improved without increase in circuit scale. It is preferred that the frequency of the sampling clock CKsp is four times or more that of the monitor signal Smnt. With this setting, the amplitude value of the digital monitor signal Dmnt can be detected correctly.

Moreover, since the clock generation circuit 101 generates the sampling clock CKsp using the monitor signal Smnt as the frequency reference, the sampling clock CKsp can be synchronized with the monitor signal Smnt. This permits correct digitization of the monitor signal Smnt, and thus the detection precision can be further improved. Not only the ADCs 102m and 102s, but also the digital circuits (the drive control circuit, the phase adjustment circuit, the detection circuit, the digital filter, etc.) of the physical quantity sensor system 11 may operate in synchronization with a clock generated using the monitor signal Smnt as the frequency reference. For example, the clock generation circuit 101 may generate operation clocks suitable for the digital circuits by multiplying the frequency of the reference clock CKr (or dividing the frequency of the sampling clock CKsp). Having such clocks, the digital circuits of the physical quantity sensor system can operate in synchronization with the monitor signal Smnt, and thus the detection precision and the precision of drive control can be further improved.

[Drive Control Circuit]

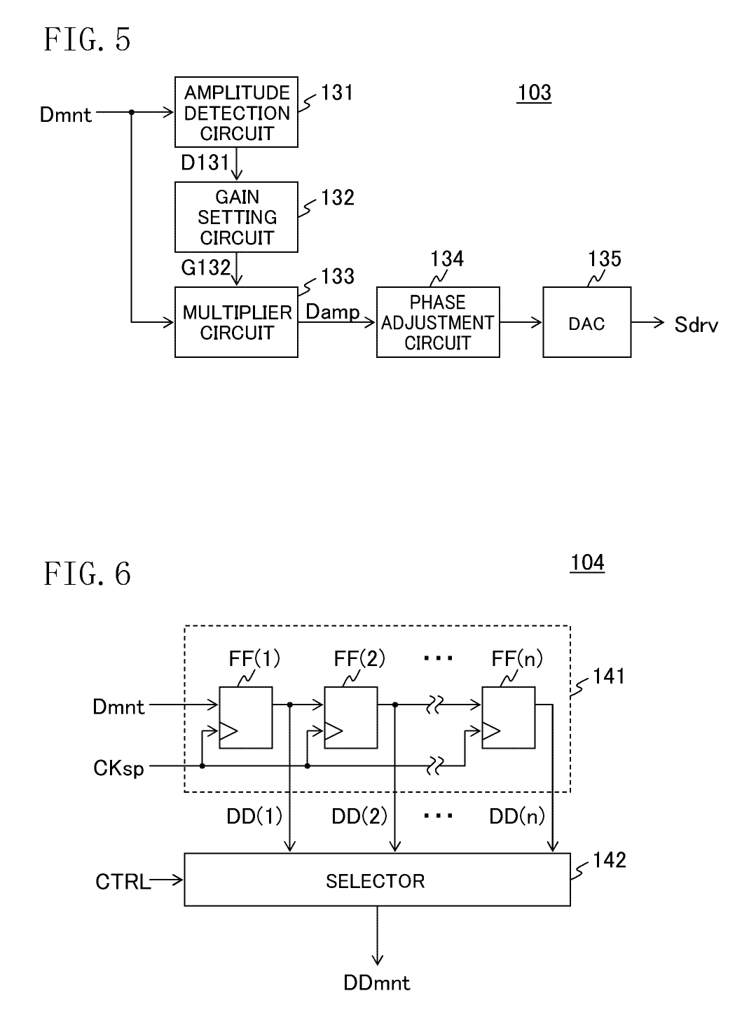

FIG. 5 shows an example configuration of the drive control circuit 103 shown in FIG. 1, which includes an amplitude detection circuit 131, a gain setting circuit 132, a multiplier circuit 133, a phase adjustment circuit 134, and a digital-to-analog converter (DAC) 135. The amplitude detection circuit 131 detects the amplitude value of the digital monitor signal Dmnt and outputs the result as an amplitude value D131 (digital value). For example, the amplitude detection circuit 131 may detect the maximum and minimum values of the digital monitor signal Dmnt and calculate the amplitude value D131 based on the difference therebetween. Otherwise, the amplitude detection circuit 131 may shift the phase of the digital monitor signal Dmnt by 90° to obtain a digital phase-shifted signal and calculate the square root of the sum of squares of the digital monitor signal Dmnt and the digital phase-shifted signal as the amplitude value D131. The gain setting circuit 132 sets a gain value G132 according to the amplitude value D131 so that the smaller the amplitude value D131, the larger the gain value G132 is. The multiplier circuit 133 multiplies the digital monitor signal Dmnt by the gain value G132 and outputs the result as a digital monitor signal Damp. The phase adjustment circuit 134 adjusts the phase of the digital monitor signal Damp so as to ensure synchronization between the monitor signal Smnt and the drive signal Sdrv. The DAC 135 converts the digital monitor signal Damp phase-adjusted by the phase adjustment circuit 134 to the drive signal S dry.

As described above, by digitizing the drive control circuit, it is possible to suppress or reduce variations in the amplitude of the drive signal Sdrv due to fluctuations in power supply voltage and changes in temperature, and thus, the vibration velocity of the physical quantity sensor 10 can be stabilized, compared with a drive circuit constituted by an analog circuit. This stabilizes the frequencies and amplitudes of the monitor signal Smnt and the sensor signal Ssnc, and hence the detection precision can be further improved. The phase adjustment circuit 134 may be placed at a stage preceding the multiplier circuit 133.

The amplitude detection circuit 131 may repeat the processing of detecting the amplitude value of the digital monitor signal Dmnt and average a plurality of amplitude values obtained by the processing, to output the result as the amplitude value D131. If frequency jitter is occurring in the monitor signal Smnt due to the self-excited vibration of the physical quantity sensor 10, the sampling points of the monitor signal Smnt may vary in the ADC 102m, causing variations in the amplitude value obtained by the amplitude detection circuit 131 even when the amplitude of the monitor signal Smnt is constant. By averaging the plurality of amplitude values, variations in amplitude value due to frequency jitter in the monitor signal Smnt can be suppressed or reduced. This permits correct control of the drive signal Sdrv, and thus the vibration velocity of the physical quantity sensor 10 can be further stabilized.

[Phase Adjustment Circuit]

FIG. 6 shows an example configuration of the phase adjustment circuit 104 shown in FIG. 1, which includes a shift register 141 and a selector 142. The shift register 141 shifts the digital monitor signal Dmnt sequentially in synchronization with the sampling clock CKsp, thereby to generate n (n is an integer equal to or more than 2) delayed digital signals DD(1), DD(2), . . . , DD(n) different in phase from one another. The shift register 141 includes n cascaded flipflops FF(1), FF(2), . . . , FF(n), for example. The selector 142 selects one of the delayed digital signals DD(1), DD(2), . . . , DD(n) according to external control CTRL (e.g., control by a digital signal processing circuit that processes the physical quantity signal D106) and outputs the selected one as the delayed digital monitor signal DDmnt. With this configuration, the phase difference between the digital monitor signal Dmnt and the digital sensor signal Dsnc can be adjusted using the period of the sampling clock CKsp as the unit.

Also, since the selector 142 outputs the delayed digital signals DD(1), DD(2), . . . , DD(n) selectively according to the external control CTRL, the phase shift amount (delay amount) of the delayed digital monitor signal DDmnt can be changed. Alternatively, the phase shift amount of the delayed digital monitor signal DDmnt may be fixed. That is, the delayed digital signal DD(n) from the shift register 141 may be supplied as the delayed digital monitor signal DDmnt, not via the selector 142. In this case, the phase shift amount of the delayed digital monitor signal DDmnt is determined according to the number of flipflops included in the shift register 141. Note that the phase adjustment circuit 134 may have a configuration similar to that of the phase adjustment circuit 104 shown in FIG. 6.

### Second Embodiment

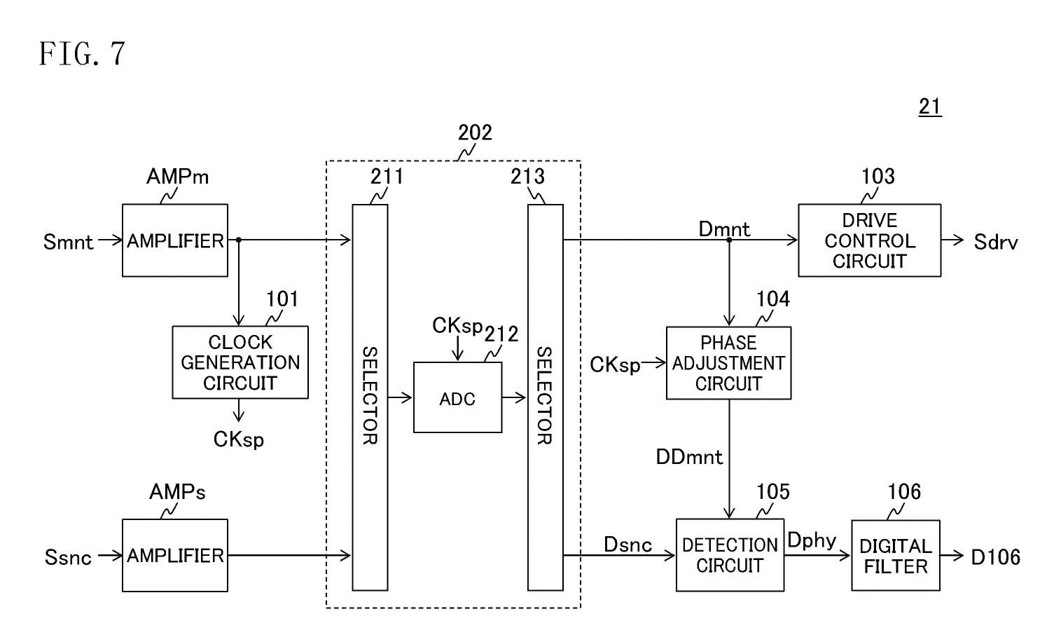

A physical quantity sensor device of the second embodiment includes a physical quantity sensor system 21 of FIG. 7 in place of the physical quantity sensor system 11 shown in FIG. 1. The physical quantity sensor system 21 is the same in configuration as that in FIG. 1 except that an analog-to-digital conversion circuit 202 is provided in place of the ADCs 102m and 102s shown in FIG. 1.

The analog-to-digital conversion circuit 202 performs analog-to-digital conversion for the monitor signal Smnt and the sensor signal Ssnc selectively, and includes selectors 211 and 213 and an analog-to-digital converter (ADC) 212, for example. The selector 211 selects the monitor signal Smnt and the sensor signal Ssnc alternately. The ADC 212 converts the signal selected by the selector 211 to a digital signal. The selector 213 supplies the digital signal from the ADC 212 to the drive control circuit 103 and the phase adjustment circuit 104 as the digital monitor signal Dmnt when the selector 211 has selected the monitor signal Smnt, or to the detection circuit 105 as the digital sensor signal Dsnc when the selector 211 has selected the sensor signal Ssnc. In this way, the monitor signal Smnt and the sensor signal Ssnc are digitized in a time-division manner.

As described above, by digitizing the monitor signal Smnt and the sensor signal Ssnc by the common ADC, the differences in amplitude and phase between the digital monitor signal Dmnt and the digital sensor signal Dsnc can be reduced. Thus, the detection precision can be further improved.

### Third Embodiment

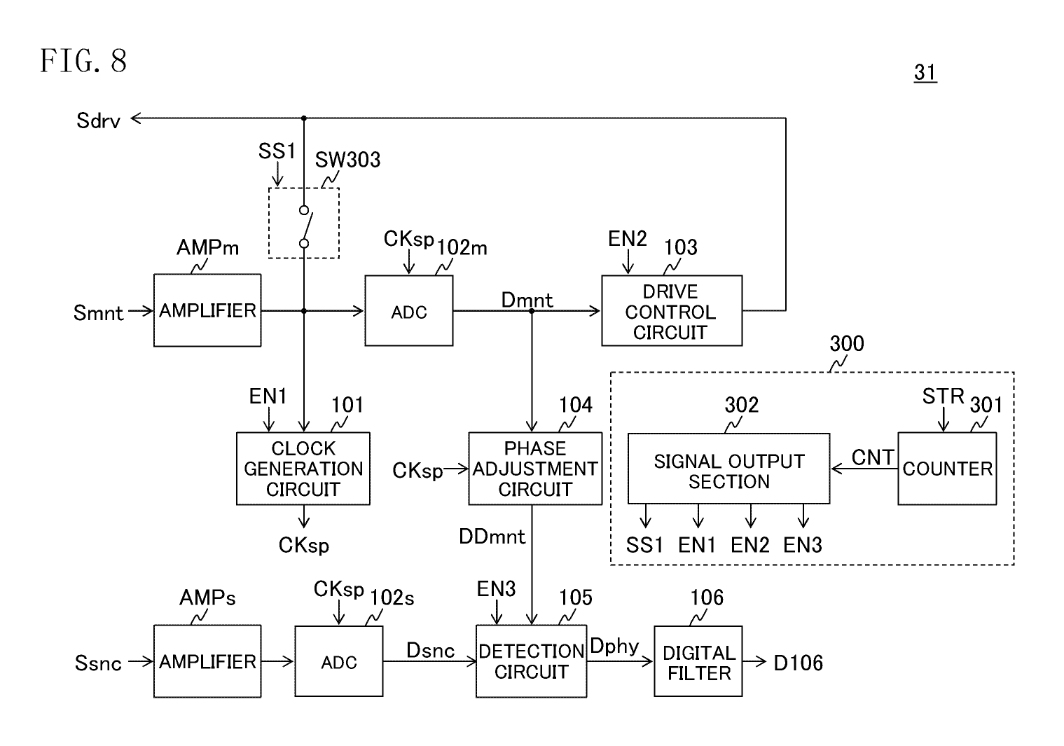

A physical quantity sensor device of the third embodiment includes a physical quantity sensor system 31 of FIG. 8 in place of the physical quantity sensor system 11 shown in FIG. 1. The physical quantity sensor system 31 includes a startup control circuit 300 and a feedback switch SW303 in addition to the components shown in FIG. 1. The startup control circuit 300 includes a counter 301 that starts counting in response to a startup start signal STR and a signal output section 302 that outputs enable signals EN1, EN2, and EN3 and a control signal SS1 based on a count value CNT from the counter 301. The clock generation circuit 101, the drive control circuit 103, and the detection circuit 105 respectively start operating in response to the enable signals EN1, EN2, and EN3. The feedback switch SW303, coupled between the amplifier AMPm and the drive piezoelectric element Pdrv of the physical quantity sensor 10, turns on/off in response to the control signal SS1.

[Startup Control]

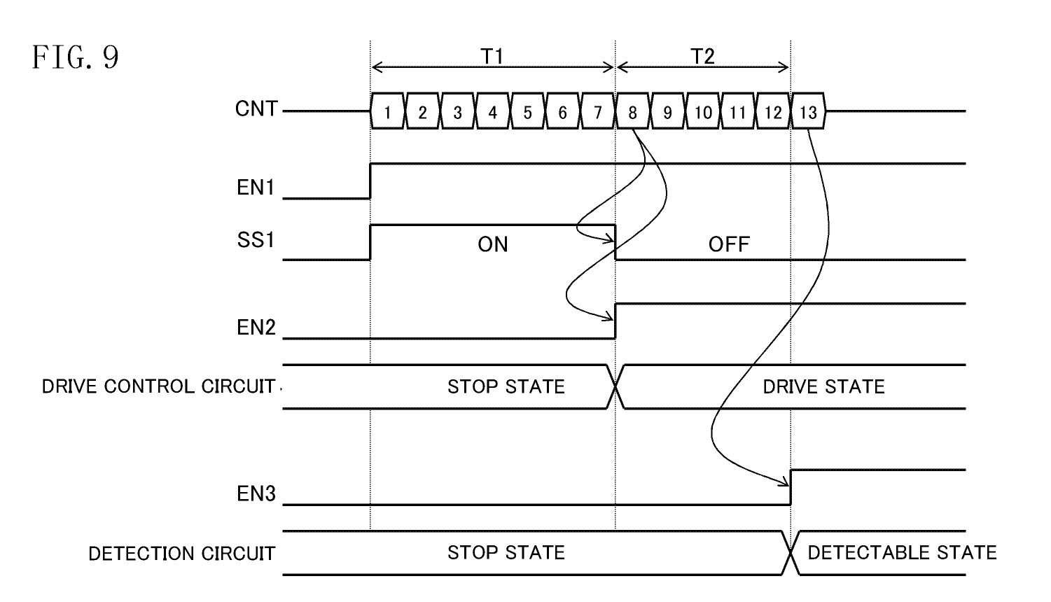

The startup control by the startup control circuit 300 shown in FIG. 8 will be described with reference to FIG. 9.

Upon supply of the startup start signal STR, the counter 301 starts counting, and the signal output section 302 starts output of the control signal SS1 to turn on the feedback switch SW303. With this switch on, the output of the amplifier AMPm is fed back to the physical quantity sensor 10 as the drive signal Sdrv. Also, the signal output section 302 starts output of the enable signal EN1 to start up the clock generation circuit 101. The clock generation circuit 101 then starts generation of the sampling clock CKsp.

After a lapse of a clock stabilizing time T1, the sampling clock CKsp becomes stable from its unstable state. For example, the frequency of the sampling clock CKsp is stabilized to a predetermined frequency (a frequency with which the ADC 102m can operate normally). At this time, the count value CNT is a first reference value (8 in the illustrated example) corresponding to the clock stabilizing time T1. When the count value CNT reaches the first reference value, the signal output section 302 stops the output of the control signal SS1 to turn off the feedback switch SW303. With this switch off, the output of the amplifier AMPm is no more fed back as the drive signal Sdrv. Also, the signal output section 302 starts output of the enable signal EN2 to start up the drive control circuit 103. The drive control circuit 103 then starts generation of the drive signal Sdrv.

After a lapse of a drive stabilizing time T2, the self-excited vibration of the physical quantity sensor 10 becomes stable from its unstable state. For example, the vibration speed of the physical quantity sensor 10 becomes constant. At this time, the count value CNT is a second reference value (13 in the illustrated example) corresponding to the sum of the clock stabilizing time T1 and the drive stabilizing time T2. When the count value CNT reaches the second reference value, the signal output section 302 outputs the enable signal EN3 to start up the detection circuit 105. The detection circuit 105 then starts detection of the physical quantity signal Dphy.

If the detection circuit 105 starts up before the self-excided vibration of the physical quantity sensor 10 becomes stable, there is a possibility that the detection circuit 105 may detect a false physical quantity signal (a physical quantity signal that does not correspond to the physical quantity given to the physical quantity sensor 10) because the amplitudes and frequencies of the monitor signal Smnt and the sensor signal Ssnc are unstable. In this embodiment, however, since the detection circuit 105 starts up after the self-excided vibration of the physical quantity sensor 10 has become stable, the detection can be performed after stabilization of the amplitudes and frequencies of the monitor signal Smnt and the sensor signal Ssnc. Thus, false detection of the physical quantity signal by the detection circuit 105 can be prevented.

If the drive control circuit 103 starts up before the sampling clock CKsp becomes stable, there is a possibility that the drive control circuit 103 may fail to control the drive signal Sdrv normally because the ADC 102m fails to operate normally. This may increase the vibration velocity of the physical quantity sensor 10 excessively, causing a possibility of breakage of the physical quantity sensor 10. In this embodiment, however, since the drive control circuit 103 starts up after the sampling clock CKsp has become stable, the drive signal Sdrv can be controlled normally based on the normal digital monitor signal Dmnt (the digital monitor signal corresponding to the monitor signal Smnt). Thus, breakage of the physical quantity sensor 10 can be prevented.

(Variation of Third Embodiment)

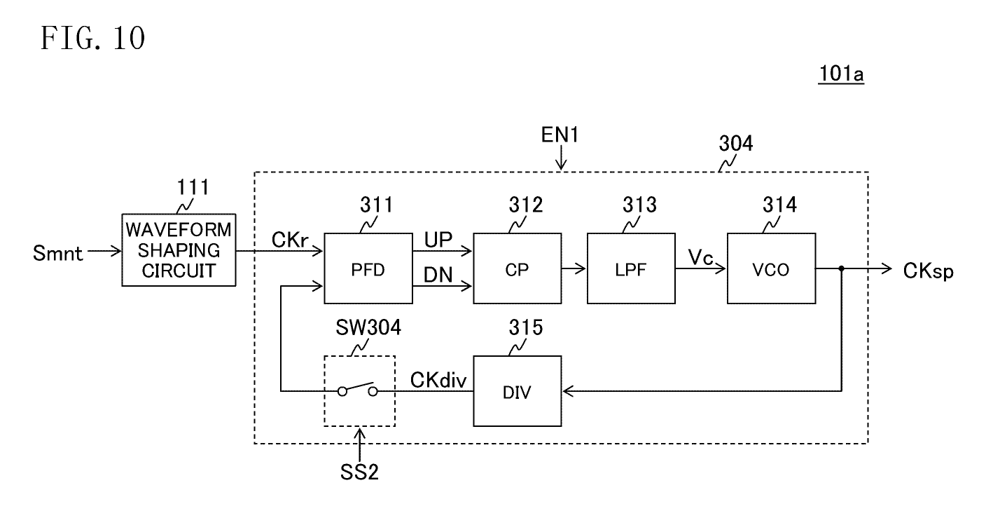

The physical quantity sensor system 31 may include a clock generation circuit 101a shown in FIG. 10 in place of the clock generation circuit 101. The clock generation circuit 101a includes the waveform shaping circuit 111 and a PLL 304 that can be switched between a closed loop state and an open loop state.

The PLL 304 includes a phase frequency detector (PFD) 311, a charge pump (CP) 312, a low-pass filter (LPF) 313, a voltage-controlled oscillator (VCO) 314, a frequency divider (DIV) 315, and a loop switch SW304. The loop switch SW304 is coupled between the frequency divider 315 and the phase frequency detector 311. The phase frequency detector 311 detects the phase difference between the reference clock CKr and a divided clock CKdiv supplied via the loop switch SW304, and outputs a charge signal UP and a discharge signal DN. The charge pump 312 increases/decreases the voltage of the low-pass filter 313 (control voltage Vc) in response to the charge signal UP/discharge signal DN. The voltage-controlled oscillator 314 adjusts the frequency of the sampling clock CKsp according to the control voltage Vc. The frequency divider 315 divides the frequency of the sampling clock CKsp and outputs the result as the divided clock CKdiv. The signal output section 302 outputs a control signal SS2 for turning on/off the loop switch SW304.

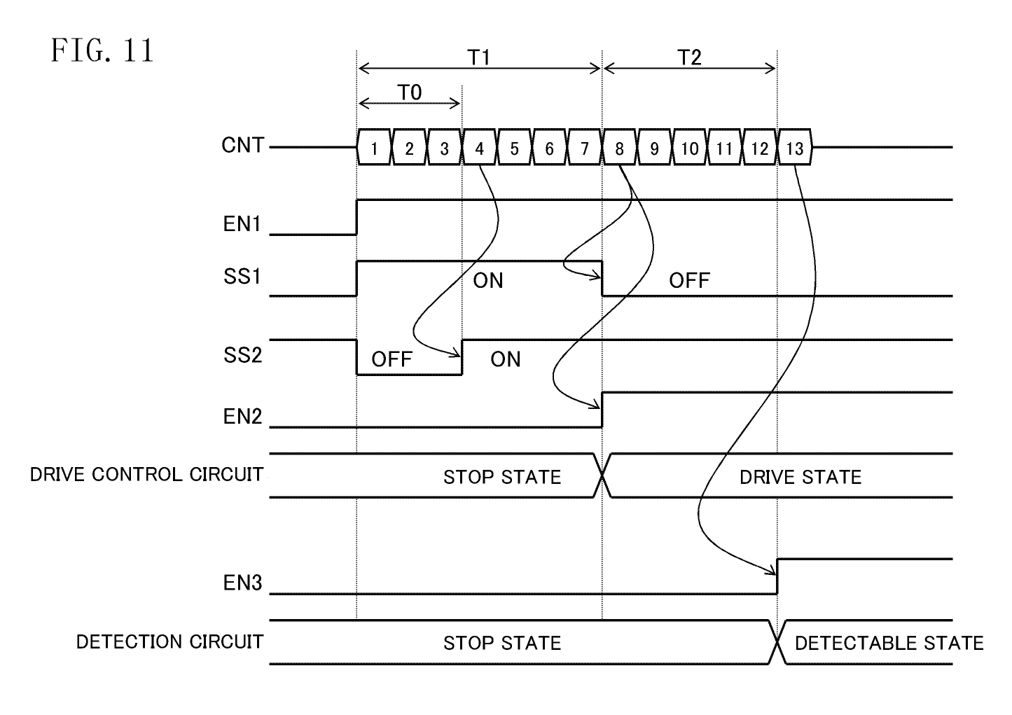

As illustrated in FIG. 11, upon supply of the startup start signal STR, the counter 301 starts counting, and the signal output section 302 stops output of the control signal SS2 to turn off the loop switch SW304. With this switch off, the PLL 304 is changed to the open loop state. After a lapse of a startup completion time TO, startup of the PLL 304 is completed. For example, the control voltage Vc reaches a predetermined value (a voltage value large enough to allow the PLL 304 to start frequency control). At this time, the count value CNT is a third reference value (4 in the illustrated example) corresponding to the startup completion time T0. When the count value CNT reaches the third reference value, the signal output section 302 starts the output of the control signal SS2, thereby changing the PLL 304 to the closed loop state.

If the PLL 304 is changed to the closed loop state before the startup of the PLL304 is not completed, there is a possibility that the frequency of the sampling clock CKsp may not be stabilized. In this embodiment, however, since the PLL 304 is set to the closed loop state after the startup of the PLL 304 is completed, it is possible to stabilize the frequency of the sampling clock CKsp.

(Variation of Startup Control Circuit)

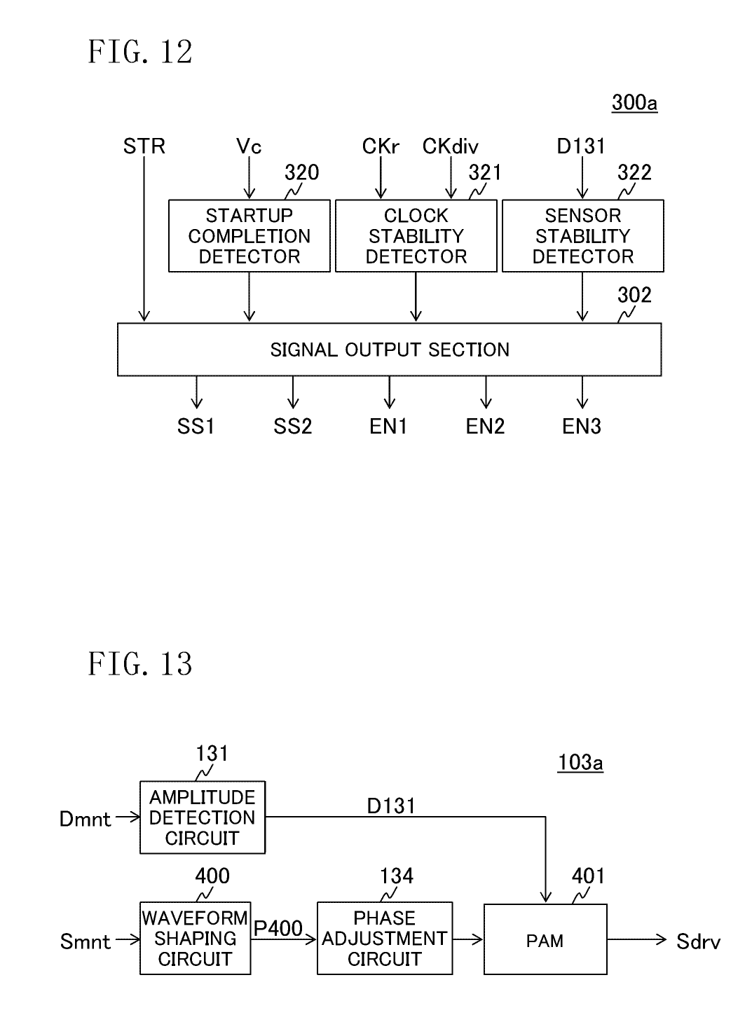

The physical quantity sensor system 31 may include a startup control circuit 300a shown in FIG. 12 in place of the startup control circuit 300. The startup control circuit 300a includes: a startup completion detector 320 that detects completion of the startup of the PLL 304; a clock stability detector 321 that detects the stability of the sampling clock CKsp; a sensor stability detector 322 that detects the stability of the self-excited vibration of the physical quantity sensor 10; and the signal output section 302. For example, the startup completion detector 320 detects that the control voltage Vc has reached a predetermined value (a voltage value large enough to allow the PLL 304 to start frequency control). The clock stability detector 321 detects that the reference clock CKr and the divided clock CKdiv are in the phase locked state. Alternatively, the clock stability detector 321 may detect that the control voltage Vc has become constant. The sensor stability detector 322 detects that the amplitude value D131 (the amplitude value of the digital monitor signal Dmnt) has become constant.

The signal output section 302 starts the output of the control signal SS1 and the enable signal EN1, and stops the output of the control signal SS2, in response to the startup start signal STR, and starts the output of the control signal SS2 in response to the detection by the startup completion detector 320. With this control, the PLL 304 is set to the closed loop state after completion of startup of the PLL 304. Also, the signal output section 302 stops the output of the control signal SS1, and starts the output of the enable signal EN2, in response to the detection by the clock stability detector 321. With this control, the drive control circuit 103 starts up after the sampling clock CKsp has become stable. Moreover, the signal output section 302 starts the output of the enable signal EN3 in response to the detection by the sensor stability detector 322. With this control, the detection circuit 105 starts up after the self-excided vibration of the physical quantity sensor 10 has become stable.

The startup control circuits 300 and 300a and the clock generation circuit 101a are also applicable to the physical quantity sensor system 21 of FIG. 7.

(Variations of Drive Control Circuit)

In the embodiments described above, each of the physical quantity sensor systems 11, 21, and 31 may include any of drive control circuits 103a, 103b, and 103c shown in FIGS. 13, 14, and 15 in place of the drive control circuit 103.

[First Variation of Drive Control Circuit]

The drive control circuit 103a of FIG. 13 includes the amplitude detection circuit 131, a waveform shaping circuit 400, the phase adjustment circuit 134, and a pulse amplitude modulation circuit (PAM) 401. The waveform shaping circuit 400 converts the monitor signal Smnt supplied via the amplifier AMPm to a square wave and outputs the result as a pulse signal P400. The waveform shaping circuit 400 is constituted by a comparator, for example. The phase adjustment circuit 134 adjusts the phase of the pulse signal P400. The PAM 401 adjusts the amplitude of the pulse signal P400 phase-adjusted by the phase adjustment circuit 134 according to the amplitude value D131 in such a manner that the smaller the amplitude value D131, the larger the amplitude of the drive signal Sdrv is, and outputs the result as the drive signal Sdrv. The larger the amplitude of the drive signal Sdrv, the higher the vibration velocity of the physical quantity sensor 10 becomes, and as a result, the larger the amplitude of the monitor signal Smnt becomes. The phase adjustment circuit 134 may be placed at a stage subsequent to the PAM 401.

In the PAM 401, noise is less likely to occur due to fluctuations in power supply voltage and changes in temperature than in a drive circuit constituted by an analog circuit. This permits correct control of the amplitude of the drive signal Sdrv. Note that the drive signal Sdrv, which is a pulse signal, includes odd harmonic components (harmonic components whose frequency is an odd multiple of the fundamental frequency). However, since the physical quantity sensor 10 has a high Q value (i.e., has a frequency response characteristic that the gain is larger as the frequency is closer to the fundamental frequency), it hardly responds to odd harmonic components. With this frequency response characteristic, it is possible to suppress or reduce fluctuations in the vibration velocity of the physical quantity sensor 10 due to odd harmonic components.

[Second Variation of Drive Control Circuit]

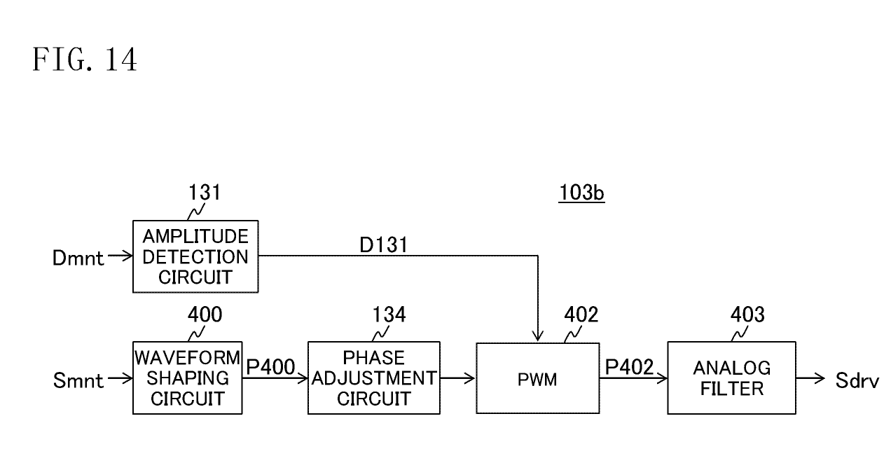

The drive control circuit 103b of FIG. 14 includes the amplitude detection circuit 131, the waveform shaping circuit 400, the phase adjustment circuit 134, a pulse width modulation circuit (PWM) 402, and an analog filter 403. The PWM 402 adjusts the duty ratio of the pulse signal P400 phase-adjusted by the phase adjustment circuit 134 according to the amplitude value D131 in such a manner that the smaller the amplitude value D131, the closer the duty ratio (the proportion of the high-level duration in one period) of the drive signal Sdrv is to 50%, and outputs the result as a drive signal P402. The analog filter 403 allows a specific frequency component (e.g., a component near the fundamental frequency) of the drive signal P402 to pass therethrough while attenuating the other frequency components, and outputs the result as the drive signal Sdrv. In this way, the waveform of the drive signal Sdrv can be brought close to a sine wave. The analog filter 403 is constituted by a band-pass filter, for example. The closer the duty ratio of the drive signal P402 to 50%, the higher the vibration velocity of the physical quantity sensor 10 becomes, and as a result, the larger the amplitude of the monitor signal Smnt becomes. The phase adjustment circuit 134 may be placed at a stage subsequent to the PWM 402. Otherwise, the phase adjustment circuit 134 may be omitted, and the phase of the drive signal Sdrv may be adjusted using the phase characteristic of the analog filter 403. The drive signal P402 may be supplied to the physical quantity sensor 10 in place of the drive signal Sdrv.

In the PWM 402, noise is less likely to occur due to fluctuations in power supply voltage and changes in temperature than in a drive circuit constituted by an analog circuit. This permits correct control of the pulse width of the drive signal Sdrv. Note that the drive signal Sdrv, which is a pulse-width modulated signal, includes harmonic components whose frequency is an integer multiple of the fundamental frequency. However, with the frequency response characteristic of the physical quantity sensor 10, it is possible to suppress or reduce fluctuations in the vibration velocity of the physical quantity sensor 10 due to harmonic components.

[Third Variation of Drive Control Circuit]

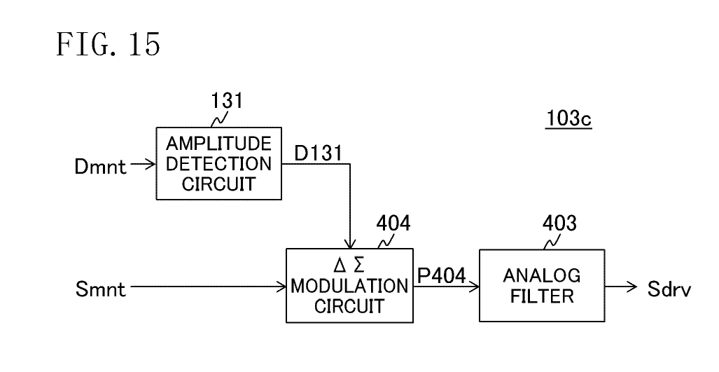

The drive control circuit 103c of FIG. 15 includes the amplifier detection circuit 131, a ΔΣ modulation circuit 404, and the analog filter 403. The ΔΣ modulation circuit 404 performs ΔΣ-modulation on the monitor signal Smnt supplied via the amplifier AMPm and outputs the result as a drive signal P404. The input gain of the ΔΣ modulation circuit 404 varies with the amplitude value D131. That is, the ΔΣ modulation circuit 404 practically receives the monitor signal Smnt amplified or attenuated according to the input gain. Also, the ΔΣ modulation circuit 404 changes the pulse density of the drive signal P404 with increase/decrease in the level of the monitor signal Smnt. The phase adjustment circuit 134 may be placed at a stage subsequent to the ΔΣ modulation circuit 404. The drive signal P404 may be supplied to the physical quantity sensor 10 in place of the drive signal Sdrv.

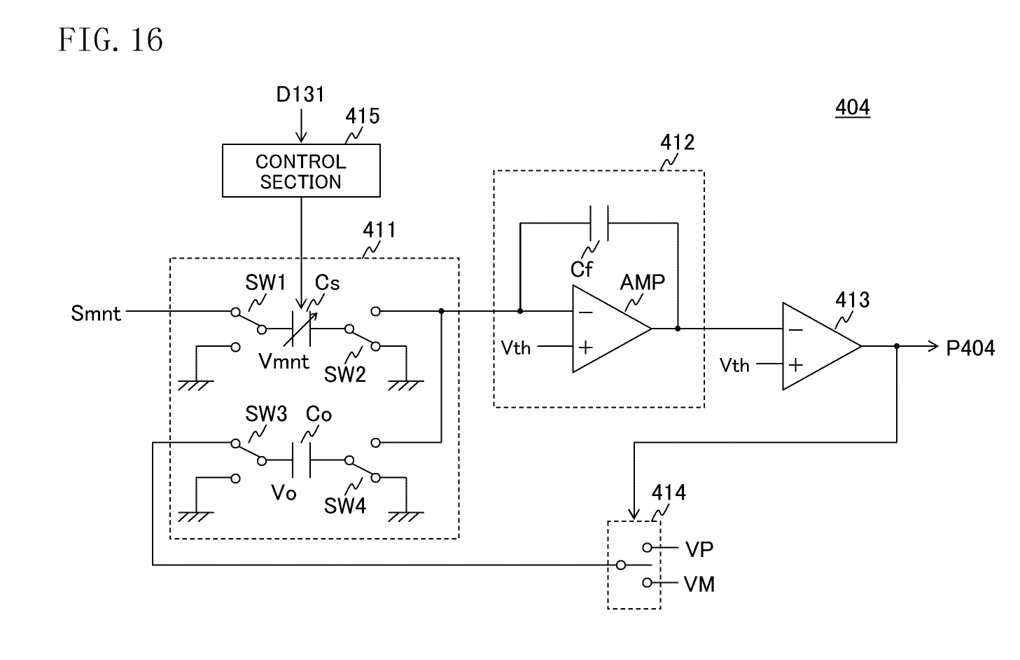

As shown in FIG. 16, the ΔΣ modulation circuit 404 includes: an operation section 411 having sampling capacitors Cs and Co and switches SW1, SW2, SW3, and SW4; an integrator 412 having an operational amplifier AMP and a feedback capacitor Cf; a comparator 413; a selector 414; and a controller 415. The sampling capacitor Cs in this embodiment is a variable capacitor.

The operation section 411 samples the monitor signal Smnt and holds a sampled voltage in the sampling capacitor Cs as a monitor voltage Vmnt, and also samples the output of the selector 414 and holds a sampled voltage in the sampling capacitor Co as an operation voltage Vo. Thereafter, the operation section 411 adds the operation voltage Vo to the monitor voltage Vmnt and outputs the added result to the integrator 412. The integrator 412 integrates the output of the operation section 411. The comparator 413 compares the output of the integrator 412 with a threshold voltage Vth (e.g., the ground voltage) thereby to digitize the output of the integrator 412, and outputs the result as the drive signal P404. The selector 414 selects one of reference voltages VP and VM according to the output of the comparator 413 and outputs the selected one to the operation section 411. The selector 414 selects the reference voltage VM lower than the threshold voltage Vth if the output of the comparator 413 is high, or selects the reference voltage VP higher than the threshold voltage Vth if it is low.

The controller 415 sets the capacitance value of the sampling capacitor Cs according to the amplitude value D131 in such a manner that the smaller the amplitude value D131, the larger the capacitance ratio of the sampling capacitor Cs to the feedback capacitor Cf (Cs/Cf) is. The larger the capacitance ratio (Cs/Cf), the larger the input gain of the ΔΣ modulation circuit 404 becomes. With increase in the input gain, the transient time (the time during which the signal level transitions comparatively frequently) of the drive signal P404 becomes short, and the high-level stable time (the time during which the frequency of occurrence of the high level is comparatively high) and the low-level stable time (the time during which the frequency of occurrence of the low level is comparatively high) become long. The longer the high-level stable time and the low-level stable time, the higher the vibration velocity of the physical quantity sensor 10 becomes, and as a result, the larger the amplitude of the monitor signal Smnt becomes. Not only the sampling capacitor Cs, but also the sampling capacitor Co and the feedback capacitor Cf may be constituted by a variable capacitor. In other words, the input gain of the A modulation circuit 404 can be adjusted by adjusting the capacitance value of at least one of the sampling capacitors Cs and Co and the feedback capacitor Cf. For example, the input gain of the A modulation circuit 404 can be increased by reducing the capacitance ratio of the sampling capacitor Co to the sampling capacitor Cs (Co/Cs).

In the ΔΣ modulation circuit 404, noise is less likely to occur due to fluctuations in power supply voltage and changes in temperature than in a drive circuit constituted by an analog circuit. This permits correct control of the pulse density of the drive signal P404. The drive signal P404, which is a ΔΣ-modulated signal, has noise components concentrated in a high frequency band higher than the reference frequency (i.e., has been noise-shaped). However, with the frequency response characteristic of the physical quantity sensor 10, it is possible to suppress or reduce fluctuations in the vibration velocity of the physical quantity sensor 10 due to the noise components in the high frequency band.

As described above, by using the pulse modulated signals (the pulse-amplitude modulated signal, the pulse-width modulated signal, and the pulse-density modulated signal) generated by the PAM 401, the PWM 402 and the ΔΣ modulation circuit 404 as the drive signal Sdrv, it is possible to suppress or reduce fluctuations in the vibration velocity of the physical quantity sensor 10 due to fluctuations in power supply voltage and changes in temperature. Thus, the detection precision of the physical quantity sensor 10 can be stabilized.

While there is a possibility of occurrence of miscoding (output of analog values that do not correspond to the digital values) in the DAC 135 shown in FIG. 5, no miscoding occurs in the PAM 401, the PWM 402 and the ΔΣ modulation circuit 404. In these circuits, therefore, the drive signal Sdrv can be controlled more correctly than in the DAC 135.

(Variations of Phase Adjustment Circuit)

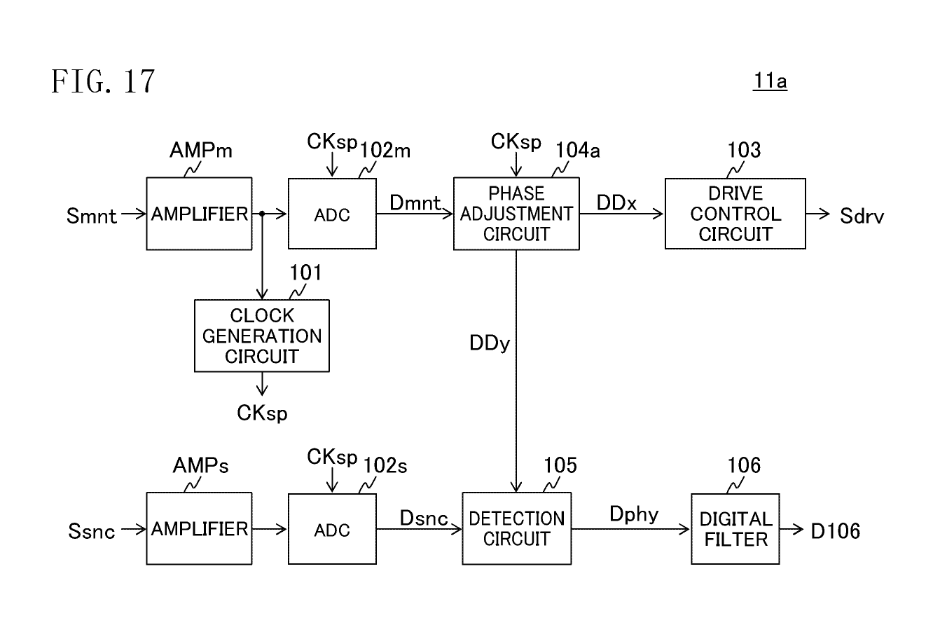

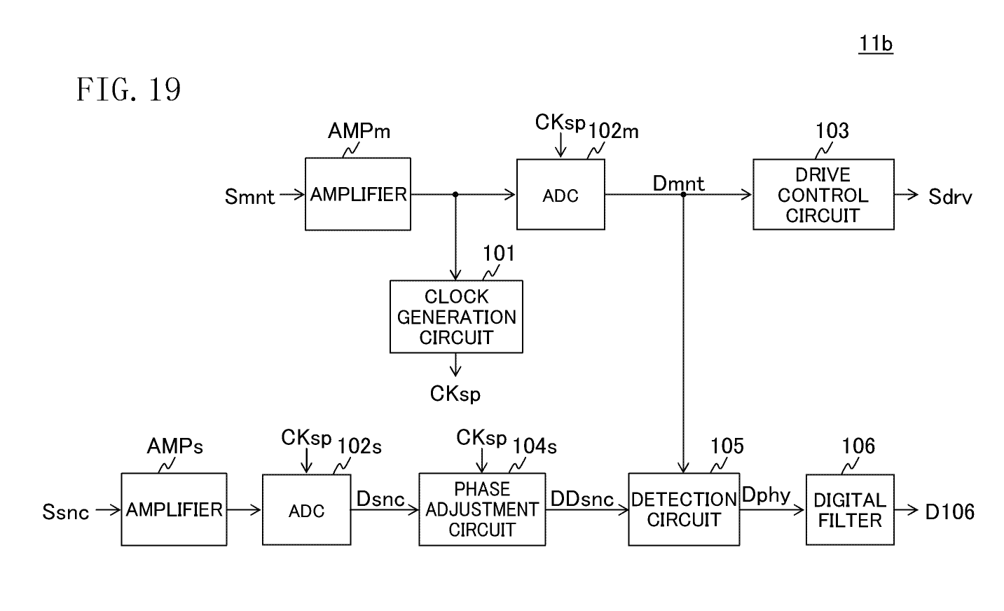

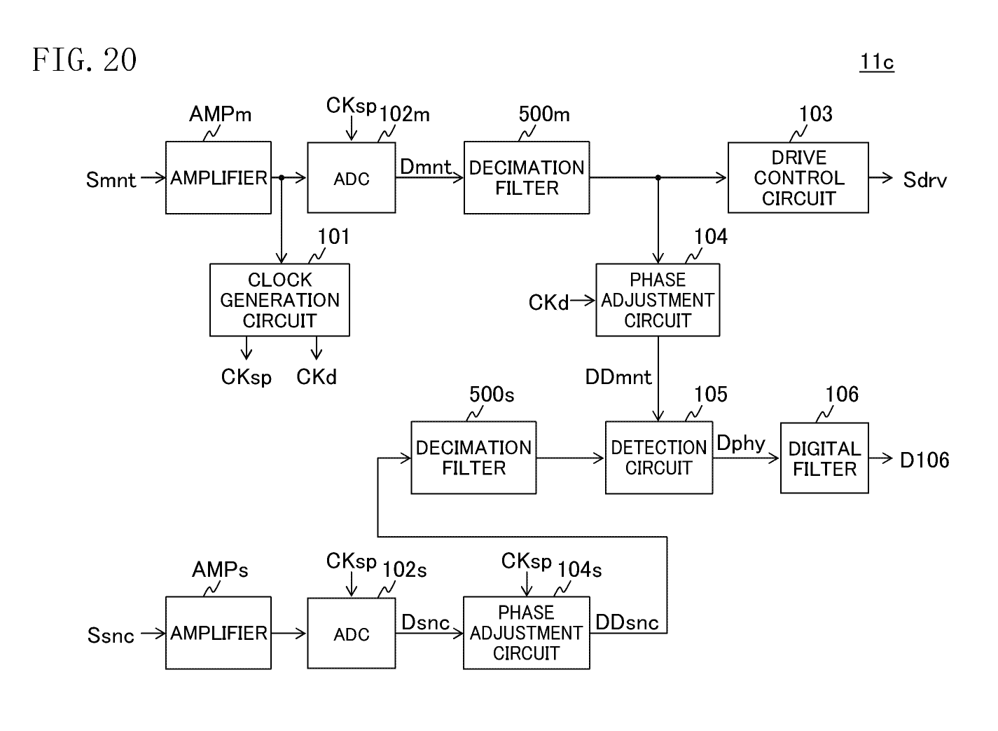

In each of the physical quantity sensor systems 11, 21, and 31, the phase adjustment circuit may be arranged as shown in FIGS. 17, 19, and 20. That is, each of the physical quantity sensor systems 11, 21, and 31 may include a phase adjustment circuit 104a shown in FIG. 17 or a phase adjustment circuit 104s shown in FIG. 19 in place of the phase adjustment circuit 104, or may include the phase adjustment circuit 104s in addition to the phase adjustment circuit 104 as shown in FIG. 20. The variations of the phase adjustment circuit will be described as follows.

[First Variation of Phase Adjustment Circuit]

A physical quantity sensor system 11a of FIG. 17 is the same in configuration as the physical quantity sensor system 11 shown in FIG. 1 except that the phase adjustment circuit 104a is provided in place of the phase adjustment circuit 104. The phase adjustment circuit 104a performs Hilbert-transformation on the digital monitor signal Dmnt, thereby to supply a digital signal DDx that lags behind the digital monitor signal Dmnt in phase to the drive control circuit 103, and also supply a digital signal DDy that leads the digital monitor signal Dmnt in phase (by about 90°) to the detection circuit 105.

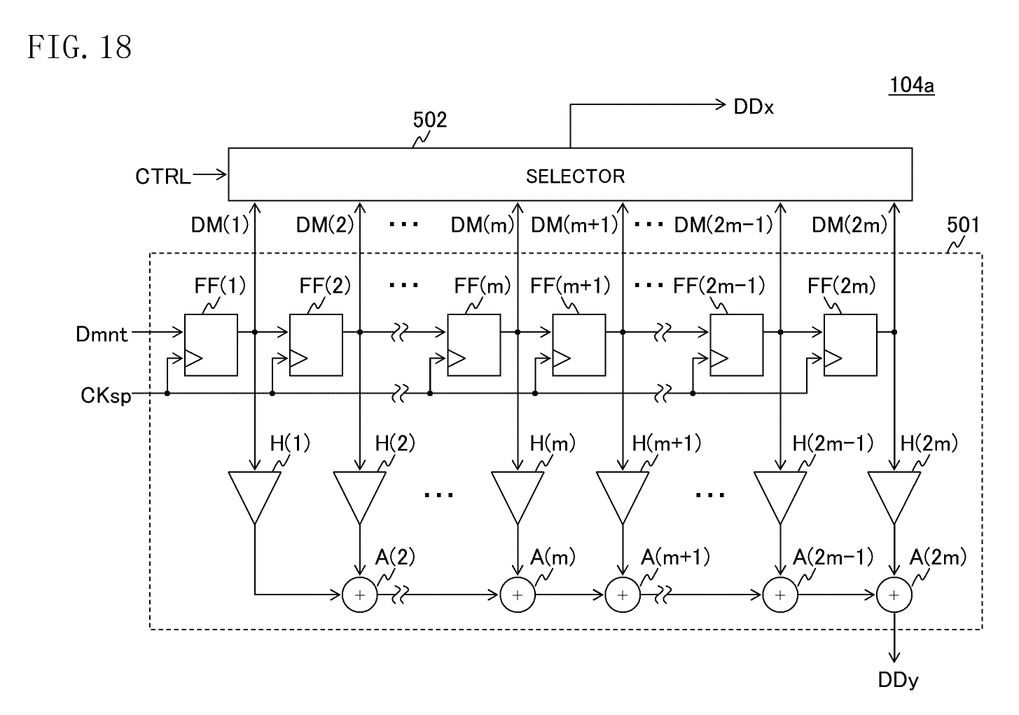

FIG. 18 shows an example configuration of the phase adjustment circuit 104a shown in FIG. 17, which includes a Hilbert transformer 501 and a selector 502. The Hilbert transformer 501 includes 2m (m is an integer equal to or more than 2) flipflops (delay circuits) FF(1), FF(2), . . . , FF(2m), 2m multipliers H(1), H(2), . . . , H(2m), and (2m−1) adders A(2), . . . , A(2m). The flipflops FF(1), FF(2), . . . , FF(2m) shift the digital monitor signal Dmnt sequentially in synchronization with the sampling clock CKsp, to generate 2m delayed digital monitor signals DM(1), DM(2), . . . , DM(2m), respectively, different in phase from one another. The multipliers H(1), H(2), . . . , H(2m) respectively multiply the delayed digital monitor signals DM(1), DM(2), . . . , DM(2m) by a constant. The adders A(2), . . . , A(2m) output the total of the outputs of the multipliers H(1), H(2), . . . , H(2m) as the digital signal DDy. The selector 502 selects one of the delayed digital monitor signals DM(1), DM(2), . . . , DM(2m) as the digital signal DDx according to the external control CTRL. Note that the phase of the digital signal DDy leads that of the delayed digital monitor signal DM(m) by 90°.

As described above, by performing Hilbert-transformation on the digital monitor signal Dmnt, the phase difference between the digital monitor signal Dmnt and the digital sensor signal Dsnc can be reduced. Also, by delaying the digital monitor signal Dmnt and supplying the delayed signal to the drive control circuit 103, it is possible to adjust the phase of the drive signal Sdrv using the period of the sampling clock CKsp as the unit. For example, when the delay amount of the digital signal DDx is set so that the monitor signal Smnt and the drive signal Sdrv synchronize with each other, the drive control circuit 103 does not have to include the phase adjustment circuit 134. Note that the digital monitor signal Dmnt may be supplied to the drive control circuit 103 directly, not via the phase adjustment circuit 104a.

Moreover, since the selector 502 outputs the delayed digital monitor signals DM(1), DM(2), . . . , DM(2m) selectively according to the external control CTRL, the phase shift amount of the digital signal DDx can be changed using the period of the sampling clock CKsp as the unit. The phase shift amount of the digital signal DDx may be fixed. In other words, one of the delayed digital monitor signals DM(1), DM(2), . . . , DM(2m) may be supplied to the drive control circuit 103 directly, not via the selector 502.

[Second Variation of Phase Adjustment Circuit]

A physical quantity sensor system 11b of FIG. 19 is the same in configuration as the physical quantity sensor system 11 shown in FIG. 1 except that the phase adjustment circuit 104s is provided in place of the phase adjustment circuit 104. The phase adjustment circuit 104s delays the digital sensor signal Dsnc and outputs the result as a delayed digital sensor signal DDsnc. For example, the phase adjustment circuit 104s includes a shift register that delays the digital sensor signal Dsnc in synchronization with the sampling clock CKsp. The configuration of the phase adjustment circuit 104s may be similar to that of the phase adjustment circuit 104 of FIG. 6. The detection circuit 105 multiplies the delayed digital sensor signal DDsnc by the digital monitor signal Dmnt. By adjusting the phase of the digital sensor signal Dsnc as described above, the phase difference between the digital sensor signal Dsnc and the digital monitor signal Dmnt can be adjusted.

[Third Variation of Phase Adjustment Circuit]

A physical quantity sensor system 11c of FIG. 20 includes the phase adjustment circuit 104s and decimation filters 500m and 500s in addition to the components of the physical quantity sensor system 11 shown in FIG. 1. The clock generation circuit 101 generates the sampling clock CKsp and an operation clock CKd having a frequency lower than the frequency of the sampling clock CKsp. To achieve this, the clock generation circuit 101 includes, in addition to the components shown in FIG. 3, a frequency division circuit that divides the frequency of the sampling clock CKsp to generate the operation clock CKd, for example. The decimation filters 500m and 500s perform decimation processing (thinning of digital values, etc.) for the digital monitor signal Dmnt and the delayed digital sensor signal DDsnc, respectively, so that the digital monitor signal Dmnt and the delayed digital sensor signal DDsnc correspond to the operation clock CKd.

The phase adjustment circuit 104 delays the digital monitor signal Dmnt supplied via the decimation filter 500m in synchronization with the operation clock Ckd having a frequency lower than the frequency of the sampling clock CKsp. Therefore, the phase adjustment precision of the phase adjustment circuit 104 is lower than that of the phase adjustment circuit 104s. In this way, by sharing the phase adjustment processing between the phase adjustment circuits 104 and 104s different in phase adjustment precision, the circuit scale and power consumption required for the phase adjustment processing can be reduced. The phase adjustment circuit 104 in FIG. 20 may be replaced with the phase adjustment circuit 104a shown in FIGS. 17 and 18.

(Variations of Clock Generation Circuit)

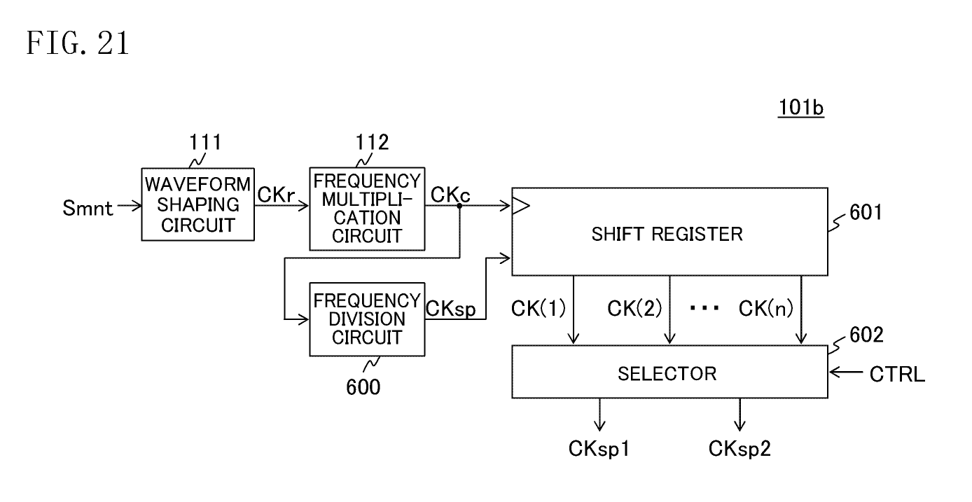

Each of the physical quantity sensor systems 11, 21, and 31 may also include any of clock generation circuits 101b, 101c, 101d, and 101e shown in FIGS. 21, 22, 23, and 24, in place of the clock generation circuit 101.

(First Variation of Clock Generation Circuit)

A clock generation circuit 101b of FIG. 21 includes the waveform shaping circuit 111, the frequency multiplication circuit 112, a frequency division circuit 600, a shift register 601, and a selector 602. The frequency division circuit 600 divides the frequency of a control clock CKc from the frequency multiplication circuit 112 and outputs the result as the sampling clock CKsp. The shift register 601 shifts the sampling clock CKsp sequentially in synchronization with the control clock CKc, to generate n (n is an integer equal to or more than 2) delayed clocks CK(1), CK(2), . . . , CK(n) different in phase from one another. The selector 602 selects ones among the delayed clocks CK(1), CK(2), . . . , CK(n) as sampling clocks CKsp1 and CKsp2 according to the external control CTRL. The sampling clocks CKsp1 and CKsp2 are respectively supplied to the ADCs 102m and 102s, for example. In the clock generation circuit 101b, the phases of the sampling clocks CKsp1 and CKsp2 can be adjusted using the period of the control clock CKc as the unit.

(Second Variation of Clock Generation Circuit)

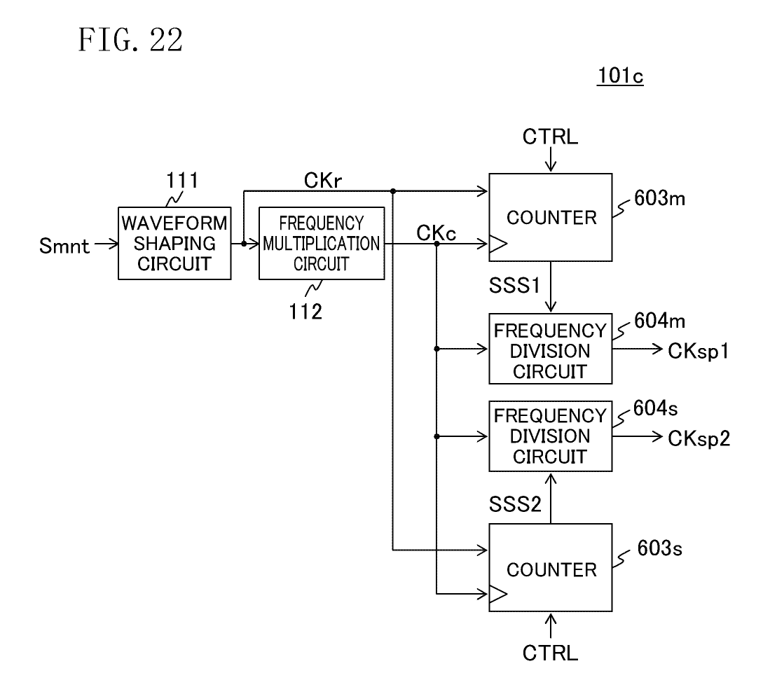

A clock generation circuit 101c of FIG. 22 includes the waveform shaping circuit 111, the frequency multiplication circuit 112, counters 603m and 603s, and frequency division circuits 604m and 604s. The counter 603m starts counting the number of generated pulses of the control clock CKc in response to a transition edge (e.g., a rising edge) of the reference clock CKr and generates a timing signal SSS1 when the number of generated pulses reaches a first predetermined value set by the external control CTRL. The counter 603s starts counting the number of generated pulses of the control clock CKc in response to a transition edge (e.g., a rising edge) of the reference clock CKr and generates a timing signal SSS2 when the number of generated pulses reaches a second predetermined value set by the external control CTRL. The frequency division circuits 604m and 604s start dividing the frequency of the control clock CKc in response to transition edges of the timing signals SSS1 and SSS2, respectively, to generate sampling clocks CKsp1 and CKsp2. In the clock generation circuit 101c, the phases of the sampling clocks CKsp1 and CKsp2 can be adjusted using the period of the control clock CKc as the unit. Also, the phase shift amounts of the sampling clocks CKsp1 and CKsp2 can be changed by changing the first and second predetermined values set for the counters 603m and 603s under the external control CTRL.

(Third Variation of Clock Generation Circuit)

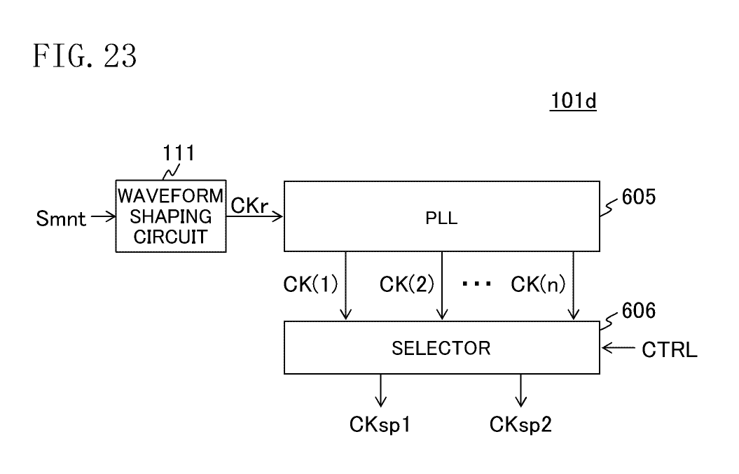

A clock generation circuit 101d of FIG. 23 includes the waveform shaping circuit 111, a PLL 605, and a selector 606. The PLL 605, which has a voltage-controlled oscillator including n (n is an integer equal to or more than 2) looped delay elements, multiplies the frequency of the reference clock CKr to generate n delayed clocks CK(1), CK(2), . . . , CK(n) different in phase from one another. Assuming that the delay time of each of the delay elements is “t”, the phases of the delayed clocks CK(1), CK(2), . . . , CK(n) are shifted by “t” each. The selector 606 selects ones among the delayed clocks CK(1), CK(2), . . . , CK(n) as sampling clocks CKsp1 and CKsp2 according to the external control CTRL. In the clock generation circuit 101d, the phases of the sampling clocks CKsp1 and CKsp2 can be adjusted in units of the delay time “t” of the delay elements.

(Fourth Variation of Clock Generation Circuit)

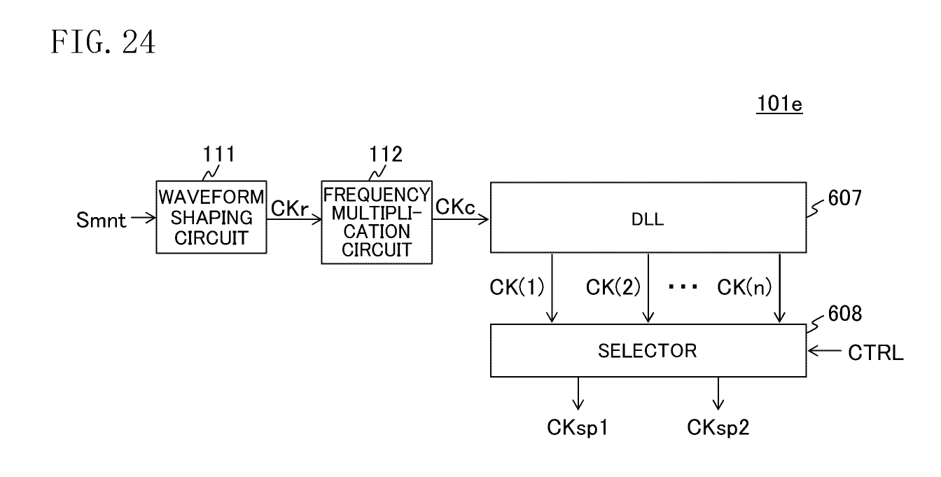

A clock generation circuit 101e of FIG. 24 includes the waveform shaping circuit 111, the frequency multiplication circuit 112, a delay locked loop (DLL) 607, and a selector 608. The DLL 607, which has a voltage-controlled delay line including n cascaded delay elements, delays the control clock CKc sequentially to generate n delayed clocks CK(1), CK(2), . . . , CK(n) different in phase from one another. Assuming that the delay time of each of the delay elements is “t”, the phases of the delayed clocks CK(1), CK(2), . . . , CK(n) are shifted by “t” each. The selector 608 selects ones among the delayed clocks CK(1), CK(2), . . . , CK(n) as sampling clocks CKsp1 and CKsp2 according to the external control CTRL. In the clock generation circuit 101e, the phases of the sampling clocks CKsp1 and CKsp2 can be adjusted in units of the delay time “t” of the delay elements.

As described above, by adjusting the phases of the sampling clocks, the phase difference can be reduced (or made zero) between the sampling clock CKsp1 and the monitor signal Smnt and also between the sampling clock CKsp2 and the sensor signal Ssnc. With this adjustment, the monitor signal Smnt and the sensor signal Ssnc can be digitized correctly, and thus the detection precision can be improved.

Also, by adjusting the phase of the sampling clock CKsp1, the sampling timing of the ADC 102m can be changed. This shifts the sampling points of the monitor signal Smnt, and thus the phase of the digital monitor signal Dmnt can be adjusted. Similarly, by adjusting the phase of the sampling clock CKsp2, the phase of the digital sensor signal Dsnc can be adjusted. Therefore, since the phase difference between the digital monitor signal Dmnt and the digital sensor signal Dsnc can be adjusted, the detection precision can be improved.

Moreover, in the clock generation circuits 101b, 101d, and 101e, since the selectors 602, 606, and 608 output the delayed clocks CK(1), CK(2), . . . , CK(n) selectively according to the external control CTRL, the phase shift amounts of the sampling clocks CKsp1 and CKsp2 can be changed. Alternatively, the phase shift amounts of the sampling clocks CKsp1 and CKsp2 may be fixed. For example, in the clock generation circuits 101b, 101d, and 101e, any of the delayed clocks CK(1), CK(2), . . . , CK(n) may be supplied as the sampling clocks CKsp1 and CKsp2 directly, not via the selectors 602, 606, and 608. In the clock generation circuit 101c, the first and second predetermined values respectively set for the counters 603m and 603s may be fixed values.

(Operation Clock)

In the embodiments described above, the ADCs 102m, 102s, and 212 may operate in synchronization with an external clock (e.g., a clock supplied from outside the physical quantity sensor system) in place of the sampling clock CKsp from the clock generation circuit 101. With this configuration, data can be synchronized between the ADCs and an external device (e.g., a digital signal processing circuit that processes the physical quantity signal D106), permitting smooth processing of the physical quantity signal D106 by the external device. Not only the ADCs 102m, 102s, and 212, but also the digital circuits (the drive control circuit, the phase adjustment circuit, the detection circuit, the digital filter, etc.) provided in the physical quantity sensor systems 11, 21, and 31 may operate in synchronization with the external clock. With this configuration, data can be synchronized between each of the digital circuits and an external device. When being supplied with an external clock, the physical quantity sensor systems 11, 21, and 31 do not have to include the clock generation circuit 101. In this case, the startup control circuits 300 and 300a may start output of the enable signal EN2 upon start of supply of the external clock, to start up the drive control circuit 103, and start output of the enable signal EN3 when the self-excited vibration of the physical quantity sensor 10 becomes stable, to start up the detection circuit 105.

(Variations of Physical Quantity Sensor)

In the embodiments described above, the physical quantity sensor 10 does not have to be of the tuning fork type, but may be of a circular cylinder type, a regular triangular prism type, a square prism type, or a ring type, or may be of another shape. In other words, the physical quantity sensor 10 may just vibrate from self-excitation by application of a drive signal Sdrv and output the monitor signal Smnt responsive to the self-excited vibration, and also output a sensor signal Ssnc according to a physical quantity given externally

Thus, the physical quantity sensor systems described above, which can stabilize the detection precision of the physical quantity sensor, are suitable for physical quantity sensors used in mobile units, cellular phones, digital cameras, game machines, etc.

It should be noted that the embodiments described above are essentially preferred illustrations and by no means intended to restrict the scope of the present invention, applications thereof, or uses thereof.

What is claimed is:

1. A physical quantity sensor system configured to drive a physical quantity sensor that vibrates from self-excitation by application of a drive signal to output a monitor signal responsive to the self-excited vibration and also output a sensor signal according to a physical quantity given externally, and detect a physical quantity signal corresponding to the physical quantity from the sensor signal, the system comprising:
an analog-to-digital conversion circuit configured to convert the monitor signal and the sensor signal to a digital monitor signal and a digital sensor signal, respectively:
a drive control circuit configured to control the drive signal according to the digital monitor signal;
a phase adjustment circuit configured to adjust the phase difference between the digital monitor signal and the digital sensor signal so that the phases of the digital monitor signal and the digital sensor signal match with each other; and
a detection circuit configured to detect the physical quantity signal by multiplying the digital monitor signal by the digital sensor signal after the phase difference adjustment by the phase adjustment circuit.

2. The system of claim 1, wherein
the analog-to-digital conversion circuit operates in synchronization with a sampling clock generated using the monitor signal as frequency reference.

3. The system of claim 2, wherein
the frequency of the sampling clock is four times or more the frequency of the monitor signal.

4. The system of claim 1, wherein
the analog-to-digital conversion circuit selectively performs first analog-to-digital conversion processing of converting the monitor signal to the digital monitor signal and second analog-to-digital conversion processing of converting the sensor signal to the digital sensor signal.

5. The system of claim 1, wherein
the analog-to-digital conversion circuit includes
a first analog-to-digital converter configured to convert the monitor signal to the digital monitor signal, and
a second analog-to-digital converter configured to convert the sensor signal to the digital sensor signal.

6. The system of claim 1, wherein
the drive control circuit includes
an amplitude detection circuit configured to detect an amplitude value of the digital monitor signal,
a gain adjustment circuit configured to amplify or attenuate the digital monitor signal according to the amplitude value detected by the amplitude detection circuit, and
a digital-to-analog conversion circuit configured to convert the digital monitor signal amplified or attenuated by the gain adjustment circuit to the drive signal.

7. The system of claim 1, wherein
the drive control circuit includes
an amplitude detection circuit configured to detect an amplitude value of the digital monitor signal, and
a pulse modulation circuit configured to adjust one of the amplitude and pulse width of a pulse signal synchronizing with the monitor signal according to the amplitude value detected by the amplitude detection circuit and output the result as the drive signal.

8. The system of claim 1, wherein
the drive control circuit includes
an amplitude detection circuit configured to detect an amplitude value of the digital monitor signal, and
a ΔΣ modulation circuit having an input gain variable according to the amplitude value detected by the amplitude detection circuit, configured to perform ΔΣ-modulation on the monitor signal and output the result as the drive signal.

9. The system of claim 1, wherein
the phase adjustment circuit includes a shift register configured to delay the digital monitor signal.

10. The system of claim 9, wherein
the shift register shifts the digital monitor signal sequentially to generate a plurality of delayed digital monitor signals different in phase from each other, and
the phase adjustment circuit includes a selector configured to select one of the plurality of delayed digital monitor signals and supply the selected one to the detection circuit.

11. The system of claim 1, wherein
the phase adjustment circuit includes a Hilbert transformer configured to perform Hilbert-transformation on the digital monitor signal to generate a first digital signal that lags behind the digital monitor signal in phase and a second digital signal that leads the digital monitor signal in phase,
the drive control circuit controls the drive signal according to the first digital signal, and
the detection circuit multiplies the digital sensor signal by the second digital signal.

12. The system of claim 11, wherein
the Hilbert transformer includes
a plurality of delay circuits configured to shift the digital monitor signal sequentially to generate a plurality of delayed digital monitor signals different in phase from each other,
a plurality of multipliers configured to multiply the plurality of delayed digital monitor signals by a constant, and
an addition circuit configured to output the total of outputs of the plurality multipliers as the second digital signal, and
the phase adjustment circuit includes a selector configured to select one of the plurality of delayed digital monitor signals and output the selected one as the first digital signal.

13. The system of claim 1, wherein
the phase adjustment circuit includes a shift register configured to delay the digital sensor signal.

14. The system of claim 13, wherein
the shift register shifts the digital sensor signal sequentially to generate a plurality of delayed digital sensor signals different in phase from each other, and
the phase adjustment circuit includes a selector configured to select one of the plurality of delayed digital sensor signals and supply the selected one to the detection circuit.

15. The system of claim 1, wherein
the phase adjustment circuit includes
first shift register configured to delay the digital monitor signal, and
a second shift register configured to delay the digital sensor signal, and
the first and second shift registers respectively operate in synchronization with first and second control clocks having different frequencies.

16. The system of claim 1, further comprising:
a sampling phase adjustment circuit configured to adjust the phase of a sampling clock,
wherein
the analog-to-digital conversion circuit operates in synchronization with the sampling clock phase-adjusted by the sampling phase adjustment circuit.

17. The system of claim 1, further comprising:
a startup control circuit configured to start up the drive control circuit and also start up the detection circuit when the self-excited vibration of the physical quantity sensor becomes stable.

18. The system of claim 17, further comprising:
an amplifier configured to amplify the monitor signal;
a feedback switch configured to be switchable between a feedback state of allowing feedback of an output of the amplifier as the drive signal and a shutoff state of prohibiting feedback of the output of the amplifier as the drive signal; and
a clock generation circuit configured to generate a sampling clock based on the output of the amplifier,
wherein
the analog-to-digital conversion circuit operates in synchronization with the sampling clock, and
the startup control circuit starts up the clock generation circuit and also sets the feedback switch to the feedback state, and, when the sampling clock becomes stable, starts up the drive control circuit and also sets the feedback switch to the shutoff state.

19. The system of claim 18, wherein
the clock generation circuit includes a phase locked loop (PLL) configured to be switchable between a closed loop state and an open loop state, and
the startup control circuit starts up the PLL in the open loop state, and sets the PLL to the closed loop state when the startup of the PLL is completed.

20. A physical quantity sensor device comprising:
a physical quantity sensor configured to vibrate from self-excitation by application of a drive signal to output a monitor signal responsive to the self-excited vibration and also output a sensor signal according to a physical quantity given externally; and
the physical quantity sensor system of claim 1.
